(19) United States
(12) Patent Application Publication
(10) Pub. No.: US 2007/0177179 A1
(43) Pub. Date: Aug. 2, 2007

(54) Print Processing System, Information Processing Apparatus and Computer Usable Medium

(75) Inventor: Masao TAKATSU, Toyohashi-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/669,498

(22) Filed: Jan. 31, 2007

(30) Foreign Application Priority Data
Jan. 31, 2006 (JP) 2006-22811
Jan. 31, 2006 (JP) 2006-22812

(51) Int. Cl. G06F 3/12

(52) U.S. Cl. 358/1.13; 358/1.15

(57) ABSTRACT

A print processing system is capable of display a setting parameter required by a user for print setting input.

### CROSS-REFERENCE TO RELATED APPLICATIONS

This application claims the benefit of Japanese Patent Application Nos. 2006-22811 and 2006-022812 both filed Jan. 31, 2006 in the Japan Patent Office, the disclosures of which are incorporated herein by reference.

### BACKGROUND

Aspects of the present invention relate to a print processing system that is designed to perform an operation of transmitting print data to a printer from an information processing apparatus, in cooperation with an application software and a printer driver functioning on the information processing apparatus.

A conventional information processing apparatus such as a personal computer (hereinafter, referred to as “PC”) usually includes a software called printer driver. Generally, there is a printer driver intended for exclusive use with each type (or manufacturer) of printers. When a printing function is operated in an application software on the information processing apparatus, the printer driver cooperates with the application software to execute a process of transmitting print data to a printer from the information processing apparatus.

This type of printer driver is generally provided with a user interface (hereinafter, referred to as “UI”) for use in setting various setting parameters related to printing (e.g., paper size, print direction, number of printing pages, enlarged/reduced printing, color/monochrome printing, resolution, and so on).

A conventional printer driver, for example, is provided with a UI for print setting input and capable of showing a dialog box including a plurality of pages With this UI, a user can switch among the pages displayed in the dialog box by selecting tabs (e.g., by clicking tabs with a pointing device) attached to the upper parts of the respective pages, and enter values to setting parameters provided on the respective pages.

### SUMMARY

Aspects of the invention relate to a print processing system capable of displaying a setting parameter required by a user for print setting input.

### BRIEF DESCRIPTION OF THE DRAWINGS

The invention will now be described below, by way of example, with reference to the accompanying drawings, in which:

FIG. 1 is a block diagram showing a schematic structure of a PC on which an application software and a printer driver according to a first and a second embodiment of the present invention operate, and a printer connected to the PC;

FIG. 2 is an explanatory diagram illustrating a transition of screen images displayed on a PC display according to the first embodiment, and events or operations that trigger off such a screen image transition;

FIGS. 3A to 3E are explanatory views, respectively, illustrating a menu displayed in an application window according to the first embodiment;

FIGS. 4A to 4C are explanatory views, respectively, illustrating a dialog box displayed by a printer driver according to the first embodiment;

FIG. 5 is a flowchart of an application process of the first embodiment;

FIG. 6 is a flowchart of a printer driver process of the first embodiment;

FIG. 7A is an explanatory view illustrating information of the printer driver obtained by the application software of the first embodiment, and FIG. 7B is an explanatory view illustrating arguments delivered to the printer driver from the application software of the first embodiment;

FIG. 8 is an explanatory diagram illustrating a transition of screen images displayed on a PC display according to the second embodiment, and events or operations that trigger off such a screen image transition;

FIGS. 9A to 9E are explanatory views, respectively, illustrating a menu displayed in an application window according to the second embodiment;

FIGS. 10A to 10C axe explanatory views, respectively, illustrating a dialog box displayed by a printer driver according to the second embodiment;

FIG. 11 is a flowchart of an application process of the second embodiment;

FIG. 12 is a flowchart of a printer driver process of the second embodiment; and

FIG. 13A is an explanatory view illustrating information of the printer driver obtained by the application software of the second embodiment, and FIG. 13B is an explanatory view illustrating arguments delivered to the printer driver from the application software of the second embodiment; and

FIG. 14 is an explanatory view showing a menu as a variation of the first and the second embodiments.

### DETAILED DESCRIPTION OF THE PREFERRED EMBODIMENT

General Overview of Various Aspects of the Invention

According to an aspect of the invention, a print processing system displays an interdialog information corresponding to at least a part of information displayed in a dialog box by a printer driver by moving a focus on a menu displayed by an application software.

According to another aspect of the invention, a print processing system makes a printer driver display a dialog regarding print settings by moving a focus on a menu displayed by an application software.

According to still another aspect of the invention, a print processing system selectively switches a plurality of group of classified setting parameters to be displayed in a dialog by moving a focus on a menu displayed by an application software.

According to still another aspect of the invention, a print processing system performs provisional display upon focus moving operation and formal display upon decisive operation. Update of setting parameters is disallowed in the provisional display, while update of the setting parameters is allowed in the formal display.

According to still another aspect of the invention, a print processing system includes an information processing apparatus, a printer that is connected to the information processing apparatus, and an application software and a printer driver that function on the information processing apparatus. The application software and the printer driver cooperate with each other to perform a process of transmitting print data from the information processing apparatus to the printer. The printer driver includes a dialog box display module that is capable of displaying a dialog box regarding print settings in response to directions from the application software. The application software includes an interdialog information acquiring module and a menu display module. The interdialog information acquiring module acquires interdialog information corresponding to at least a part of information displayed in the dialog box by the printer driver. The menu display module is capable of displaying a menu having a hierarchical structure including print directive items provided for directing the printer driver to display the dialog box. When there is an operation of moving a focus to the print directive items, the menu display module displays the interdialog information obtained by the interdialog information acquiring module as a submenu of the print directive items.

According to still another aspect of the invention, a print processing system includes an information processing apparatus, a printer that is connected to the information apparatus, and an application software and a printer driver that function on the information processing apparatus. The application software and the printer driver cooperate with each other to perform a process of transmitting print data to the printer from the information processing apparatus. The printer driver includes a dialog box display module. The dialog box display module is capable of displaying a dialog box regarding print settings in response to directions from the application software. When displaying the dialog box, the dialog box display module displays setting parameters belonging to one of a plurality of groups specified by the application software as initial display contents. The application software includes a group information acquiring module, a menu display module, and a dialog box display directive module. The group information acquiring module obtains a plurality of group information corresponding to the plurality of groups. The menu display module is capable of displaying a menu having a hierarchical structure. The menu display module includes print directive items provided for directing the printer driver to display the dialog box. When there is an operation of moving a focus to the print directive items, the menu display module displays the plurality of group information obtained by the group information acquiring module as a submenu of the print directive items. The dialog box display directive module specifies one of the groups corresponding to one of the group information to which the focus is moved every time there is an operation of moving a focus to any of the plurality of group information in the menu displayed by the menu display module, and directs the printer driver to display the dialog box.

In the above print processing system, the interdialog information acquiring module may be designed to obtain the interdialog information from anywhere. For example, if the interdialog information is to be registered in a registry (storage area managed by an OS (operation system)) at the time of installation of the printer driver, the interdialog information may be acquired from the registry. Or, if the interdialog information is stored in a file which can be accessed from the application software, the group information may be read from the file. Or, if a process related to the printer driver is resident in memory, the interdialog information may be received by process-to-process communication.

In the print processing system, the printer driver may further include a display direction type determination module and a setting change restriction module. The display direction type determination module may determine whether the directions received from the application software are directions for provisional display or for formal display. When it is determined that the directions for formal display are received from the application software, the setting change restriction module may urge the dialog box display module to display the dialog box, and accept operation to controls in the dialog box and change parameter values of the setting parameters. When it is determined that directions for provisional display are received from the application software, the setting change restriction module may urge the dialog box display module to display the dialog box but accept no operation to the controls in the dialog box so as to prohibit any change to the parameter values of the setting parameters. The dialog box display module of the application software may send the directions for provisional display to the printer driver every time an operation of moving a focus to any of the plurality of group information in the menu displayed by the menu display module. When an operation of confirming selection of the group information, the setting change restriction module may send the directions for formal display to the printer driver.

### First Embodiment

[Structure of Overall System]

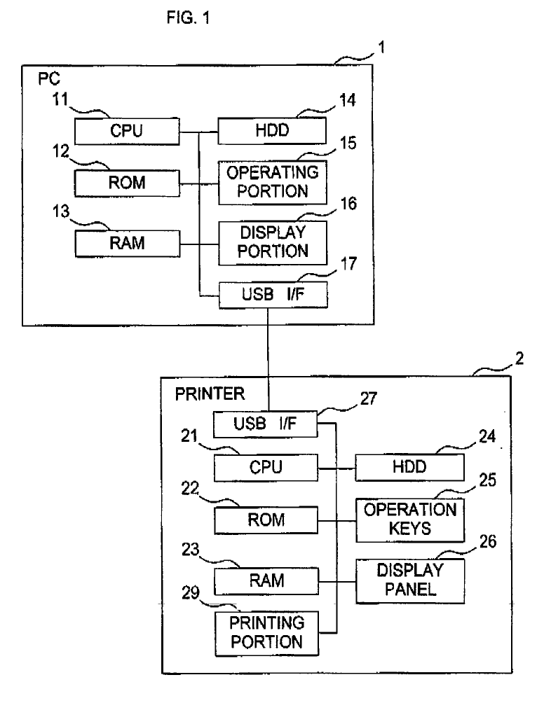

Referring to FIG. 1, a print processing system of the present embodiment is provided with a personal computer (hereinafter, referred to as “PC”) 1 and a printer 2 connected to the PC 1. In the print processing system an application software and a printer driver that junction on the PC 1 cooperate with each other to execute a process of transmitting print data from the PC 1 to the printer 2.

The PC 1 includes a CPU 11, a ROM 12, a RAM 13, a hard disk drive (hereinafter, referred to as “HDD”) 14, an operating portion 15, a display portion 16, and a USB (Universal Serial Bus) interface (hereinafter, referred to as “USB I/F”) 17.

The CPU 11 controls respective portions of the PC 1 and executes various calculations according to programs stored in the ROM 12 and the RAM 13. The CPU 11 executes an application process and a printer driver process which will be explained later on.

The ROM 12 is a memory device that is capable of maintaining memory content even after the PC 1 is powered off. The ROM 12 stores a BIOS (Basic Input Output System) and various read-only data.

The RAM 13 is a memory device for use as a main memory directly accessed by the CPU 11. The RAM 13 stores an OS (Operating System) and various application programs and data files read out from the HDD 14. The RAM 13 also stores results of various calculations performed by the CPU 11.

The HDD 14 stores the OS, various application programs and various data files. The aforementioned application program and printer driver program are also stored in the HDD 14.

The operating portion 15 is an input device for use by a user to input various directions. The operating portion 15 is composed, for example, of a keyboard and various pointing devices (like a mouse).

The display portion 16 is an output device to present various information to a user. The display portion 16 is composed, for example, of a liquid crystal display that is capable of displaying color images.

The USB I/F 17 is a serial interface that can be connected to a printer and other peripheral apparatus.

In the present embodiment, a multitask OS is installed on the PC 1. Accordingly, a plurality of tasks can be performed in parallel. In the PC 1, the plurality of tasks cooperate with each other in order to accomplish various processes. The application software and printer driver operating in the printing process system of the present invention includes one or more tasks that are performed under control of the multitask OS. The tasks of the application software and the printer driver cooperate with each other in order to execute a process of transmitting print data to the printer 2 from the PC 1. The OS installed on the PC 1 is also a multi-window OS. Each of the application software and the printer driver is designed to display a window as a UI under control of the OS. Particular examples of such OS are Windows® and MacOS®, Various functions provided with these types of OS are well-known. Therefore, detailed explanation on the functions is omitted. However, it should be pointed out that the PC 1 has the various functions as those can be offered by the aforementioned OS.

The printer 2 includes a CPU 21, a ROM 22, a RAM 23, a HDD 24, operation keys 25, a display panel 26, a USB I/F 27, and a printing portion 294

The CPU 21 controls respective portions of the printer 2 according to control programs stored in the ROM 22. The CPU 21 also executes various calculations.

The ROM 22 is a memory device that is capable of maintaining memory content even after the printer 2 is powered off. The ROM 22 stores various read-only data.

The RAM 23 is a memory device for use as a main memory directly accessed by the CPU 21. The RAM 23 temporarily stores various data calculated by the CPU 21 during its operation.

The HDD 24 is a memory device for storing data that is too large to be stored in the RAM 23.

The operation keys 25 serve as an input device for use by a user to manually provide directions to the printer 2.

The display panel 26 is composed of a small liquid crystal display. The display panel 26 is designed to display information such as settings and status of the printer 2.

The USB I/F 27 is a serial interface that allows connection of a PC.

The printing portion 29 is composed of a conveying mechanism and a recording mechanism. The conveying mechanism conveys a sheet-like medium (e.g., recording paper) from a feeding portion to a discharge portion. The recording mechanism records an image onto the medium in process of conveyance by the conveying mechanism.

[Outline of UI in Print Processing System]

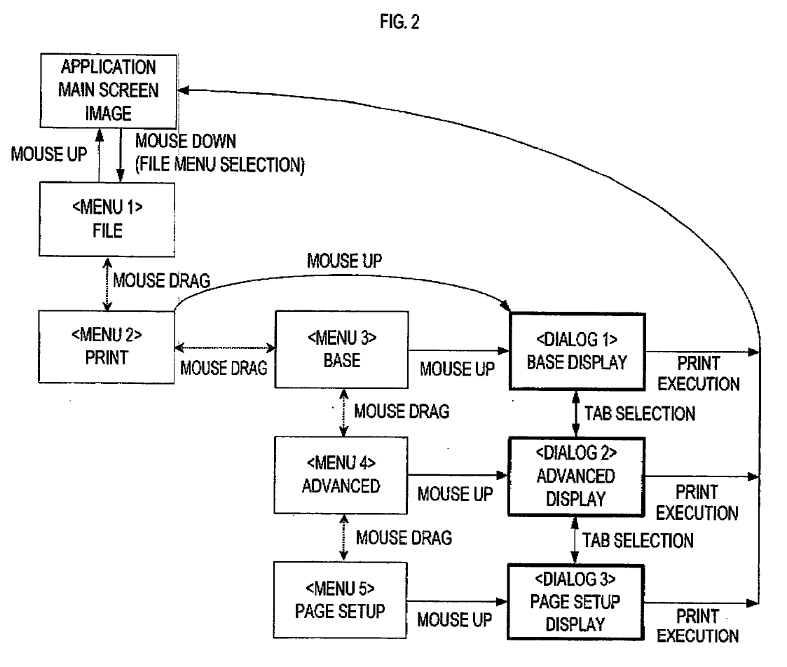

Now, the outline of a UI provided in the print processing system that operates on the PC 1 will be described by way of FIGS. 2, 3A to 3E and 4A to 4C.

In the following description, a mouse is used as a pointing device. An operation of depressing the button of the mouse is referred to as a mouse down operation. An operation of releasing the button is referred to as a mouse up operation. An operation of moving a mouse cursor after the mouse down operation without the mouse up operation is referred to as a mouse drag operation. A quick performance of the mouse down operation and the subsequent mouse up operation is referred to as a click operation. As is known in general, various mouse operations in a PC can be reproduced by other input devices like a keyboard. In the following description, alternative operations which can be determined as the mouse down operation, the mouse up operation, the mouse drag operation or the click operation by the PC 1 can be conducted by means of other input devices. However, the point of the present invention is not that the alternative operations can be performed by other input devices. Furthermore, it will be complex if description is provided for all alternative operations by other output devices. Therefore, only the operations by the mouse will be described in the following description. The particular description of the alternative operations by other input devices will be omitted.

Referring to FIG. 2, an application main screen image, which is located on the upper left upper position of FIG. 2 drawing, is firstly shown on the display portion 16 of the PC 1 when an application software is started on the PC 1.

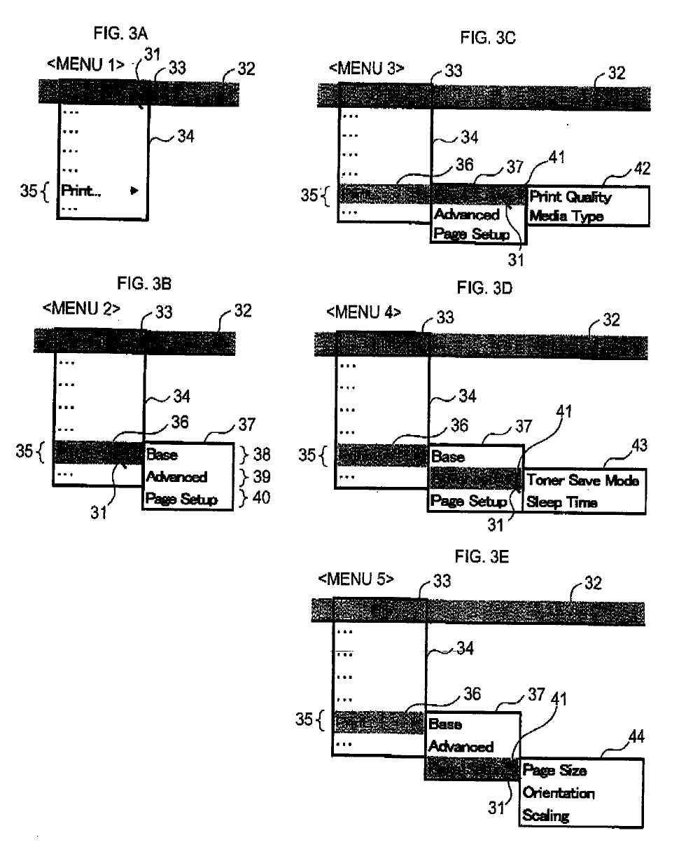

In the application main screen image, a user can shift the screen image shown by the application software to another screen image shown as <Menu 1> in FIG. 2, by performing a “File” menu selecting operation. More particularly, as shown in FIG. 3A, the application main screen image including a mouse cursor 31 which moves in accordance with a mouse operation and a menu bar 32 is displayed on the display portion 16 of the PC 1. Here, if the user points the item “File” 33 in the menu bar 32 with the mouse cursor 31 by a mouse operation and performs the mouse down operation, it is considered that the “File” menu selecting operation has been conducted. When the “File” menu selecting operation is performed, a “File” menu 34 is shown on the display portion 16. As a result the screen image has shifted to <Menu 1> in FIG. 2. An item “Print” 35 is also displayed with other items in the “File” menu 34.

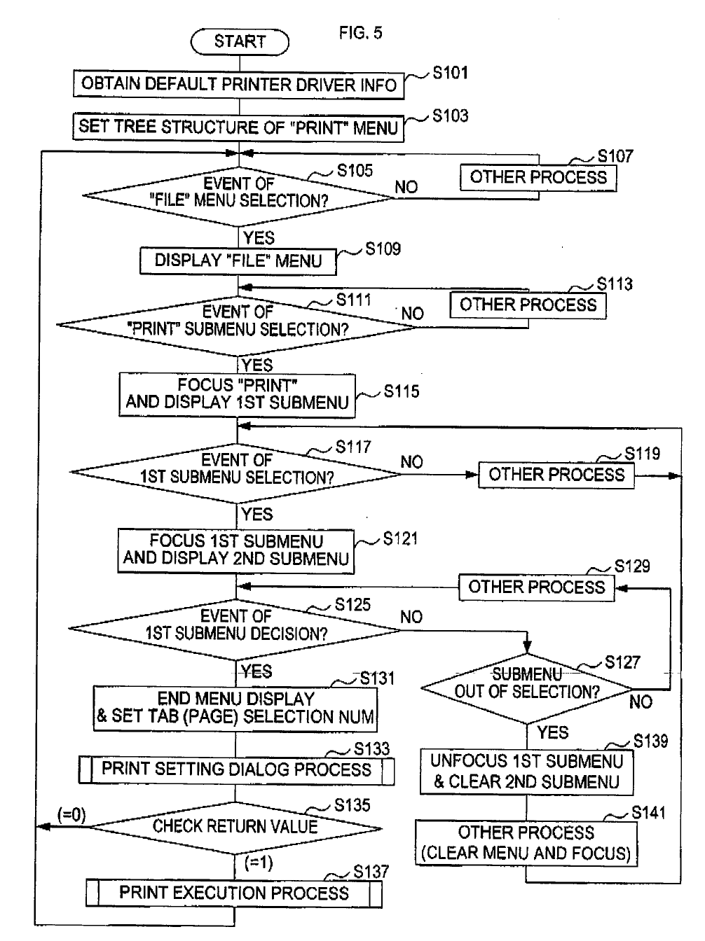

Next, the user can shift the screen image displayed by the application software from <Menu 1> to <Menu 2> in FIG. 2 by performing the mouse drag operation. More particularly, as shown in FIG. 5B, following the mouse down operation corresponding to the “File” menu selecting operation, the user moves the mouse cursor 31 into the “File” menu 34 by performing the mouse drag operation. Then, a focus 36 which follows the movement of the mouse cursor 31 appears in the “File” menu 34. When the user moves the focus 36 to the item “Print” 35, a “Print” submenu 37 is shown adjacent to the item “Print” 35. In this manner, the screen image is changed to <Menu 2>. The “Print” submenu 37 includes items like “Base” 38, “Advanced” 39 and “Page Setup” 40. The respective items shown in the “Print” submenu 37 indicate what subpages there are in a later-explained print setting dialog. The texts “Base”, “Advanced” and “Page Setup” shown here are information registered in a registry by a printer driver. The information is obtained from the registry by the application software and displayed in the “Print” submenu 37.

Next, the user can shift the screen image displayed by the application software from <Menu 2> to <Menu 3> in FIG. 2 by continuing the mouse drag operation. More particularly, as shown in FIG. 5C, when the user continues the mouse drag operation to move the mouse cursor 31 into the “Print” submenu 37, a focus 41 which follows the movement of the mouse cursor 31 appears in the “Print” submenu 37. When the user moves the focus 41 to the item “Base” 38, a “Base” submenu 42 is shown adjacent to the item “Base” 38. In this manner, the screen image is changed to <Menu 3>. The “Base” submenu 42 includes items like “Print Quality” and “Media Type”. The respective items shown in the “Base” submenu 42 indicate what subpages there are in the “Base” subpage in the later-explained print setting dialog. The texts “Print Quality” and “Media Type” shown here are, as well as the texts in the “Print” submenu 37, information registered in a registry by a printer driver. The information is obtained from the registry by the application software and displayed in the “Base” submenu 42.

Next, the user can shift the screen image displayed by the application software from <Menu 3> to <Menu 4> in FIG. 2 by continuing the mouse drag operation. More particularly, as shown in FIG. 3D, when the user continues the mouse drag operation to move the focus 41 to the item “Advanced” 39, a “Advanced” submenu 43 is shown adjacent to the item “Advanced” 39. In this manner, the screen image is changed to <Menu 4>. The “Advanced” submenu 43 includes items like “Toner Save Mode” and “Sleep Time”. The respective items shown in the “Advanced” submenu 43 indicate what subpages there are in the “Advanced” subpage in the later-explained print setting dialog. The texts “Toner Save Mode” and “Sleep Time” shown here are, as well as the texts in the “Print” submenu 37 or in the “Base” submenu 42, information registered in a registry by a printer driver. The information is obtained from the registry by the application software and displayed in the “Base” submenu 42.

Next, the user can shift the screen image displayed by the application software from <Menu 4> to <Menu 5> in FIG. 2 by continuing the mouse drag operation. More particularly, as shown in FIG. 5E, when the user continues the mouse drag operation to move the focus 41 to the item “Page Setup” 40, a “Page Setup” submenu 44 is shown adjacent to the item “Page Setup” 40. In this manner, the screen image is changed to <Menu 5>. The “Page Setup” submenu 44 includes items like “Page Size”, “Orientation” and “Scaling”. The respective items shown in the “Page Setup” submenu 44 indicate what subpages there are in the “Page Setup” subpage in the later-explained print setting dialog. The texts “Page Size”, “Orientation” and “Scaling” shown here are, as well as the texts in the “Print” submenu 37, in the “Base” submenu 42 or in the “Advanced” submenu 43, information registered in a registry by a printer driver. The information is obtained from the registry by the application software and displayed in the “Page Setup” submenu 44.

The above described screen image transition from <Menu 1> to <Menu 5> is continued as long as the user continues the mouse drag operation. Every time the screen image transition to <Menu 3>, <Menu 4> or <Menu 5> occurs, the “Base” submenu 42, the “Advanced” submenu 43 or the “Page Setup” submenu is displayed.

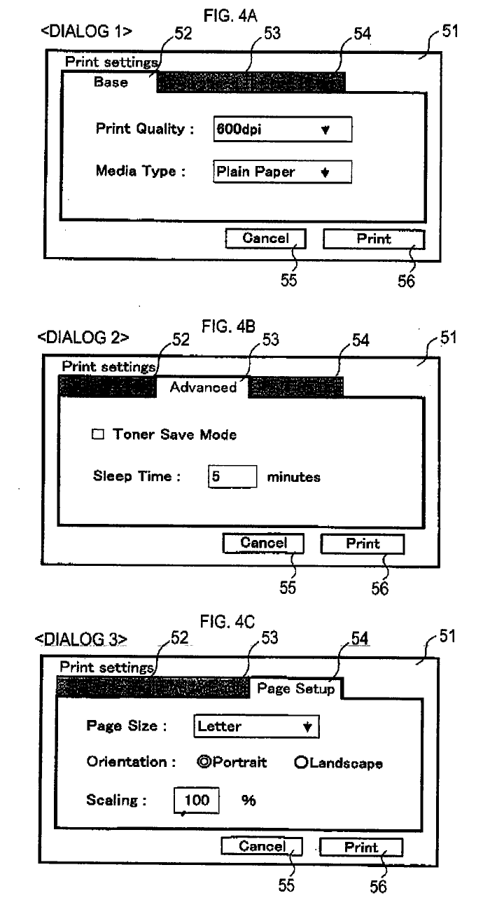

When the user performing the mouse drag operation performs the mouse up operation when the screen image displayed by the application software is shifted to <Menu 3>, <Menu 4> or <Menu 5>, a selecting operation of the item “Base” 38, “Advanced” 30 or “Page Setup” 40 is confirmed. All the items “Base” 38, “Advanced” 39 and “Page Setup” 40 indicate submenus for print directions provided for directing the printer driver to display a print setting dialog box 51. Once a selecting operation for any of the items is confirmed, the application software sends directions to the printer driver to display the dialog. The printer driver which received the directions displays the print setting dialog box shown in FIGS. 4A to 4C. At the same time, in the screen image displayed by the application software, the whole hierarchical menu including the “File” menu 34 and onwards (the “File” menu 34 and the “Print” submenu 37 in FIGS. 3A to 3E) disappears.

The print setting dialog box 51 displayed by the printer driver includes a “Base” subpage 52, an “Advanced” subpage 53, a “Page Setup” subpage 54, a Cancel button 56 and a Print button 56. The “Base” subpage 52, the “Advanced” subpage 53 and the “Page Setup” subpage 54 include various controls for input or selection of values for setting parameters classified by similar functions as shown in FIGS. 4A to 40.

The “Base” subpage 52, the “Advanced” subpage 53 and the “Page Setup” subpage 54 are displayed in layers. Only one of the subpages is displayed at the forefront. Which subpage is shown at the forefront is specified on the application software side. The printer driver displays the subpage specified by the application software at the forefront.

If the user performing the mouse drag operation performs the mouse up operation when the screen image is shifted to <Menu 3> shown in FIG. 2, the application software sends directions to the printer driver to display the print setting dialog box 51 while specifying the “Base” subpage 52. This is because the item “Base” 38 on which the focus 41 has moved is associated with the “Base” subpage 52. As a result, the print setting dialog box 51 is displayed such that the “Base” subpage 52 is shown at the forefront.

If the user performing the mouse drag operation performs the mouse up operation when the screen image is shifted to <Menu 4> shown in FIG. 2, the application software sends directions to the printer driver to display the print setting dialog box 51 while specifying the “Advanced” subpage 53. This is because the item “Advanced” 39 on which the focus 41 has moved is associated with the “Advanced” subpage 53. As a result, the print setting dialog box 51 is displayed such that the “Advanced” subpage 53 is shown at the forefront.

If the user performing the mouse drag operation performs the mouse up operation when the screen image is shifted to <Menu 5> shown in FIG. 2, the application software sends directions to the printer driver to display the print setting dialog box 51 while specifying the “Page Setup” subpage 54. This is because the item “Page Setup” 40 on which the focus 41 has moved is associated with the “Page Setup” subpage 54. As a result, the print setting dialog box 51 is displayed such that the “Page Setup” subpage 54 is shown at the forefront.

In the following description, the state having the “Base” subpage 52 displayed at the forefront as shown in FIG. 4A is referred to as <Dialog 1>. The state having the “Advanced” subpage 53 displayed at the forefront as shown in FIG. 4B is referred to as <Dialog 2>. The state having the “Page Setup” subpage 54 displayed at the forefront as shown in FIG. 4C is referred to as <Dialog 3>.

Various operations in the print setting dialog box 51 can be performed when the print setting dialog box 51 is displayed. For example, if the user selects any of the “Base” subpage 52, the “Advanced” subpage 53 or the “Page Setup” subpage 54 (i.e., clicks one of tabs attached to the upper parts of the respective subpages using the mouse), the display content of the print setting dialog box 51 can be switched to any of <Dialog 1>, <Dialog 2> or <Dialog 3>. Also, the user, after entering desired print settings through input operations to the various controls provided in the respective subpages, can click a Print button 56 in the print setting dialog box 51 to send directions for printing to the printer 2. When the directions for printing are sent to the printer 2, the application software and the printer driver together performs a process of transmitting print data to the printer 2 from the PC 1 in the same manner as in the prior art. At the same time, the print setting dialog box 51 is cleared by the printer driver. The application main screen image displayed by the application software remains on the display portion 16 of the PC 1.

If the user performs the mouse up operation immediately after the screen image is shifted to <Menu 2>, the whole hierarchical menu including the “File” menu 34 and onward (the “File” menu 34 and the “Print” submenu 37 in FIGS. 3A to 3E) disappears in the image screen displayed by the application software. The printer driver displays <Dialog 1>. In other words, only when <Dialog 1> is desired to be displayed, the mouse up operation may be performed immediately after the screen image is shifted to <Menu 2>. In this case, however, the aforementioned display of the “Base” submenu 42, the “Advanced” submenu 43, and the “Page Setup” submenu 44 is nor performed. This behavior is the same as the behavior in the prior art when a UI of a printer driver is called up by an application software.

[Process Performed by Application Software and Printer Driver]

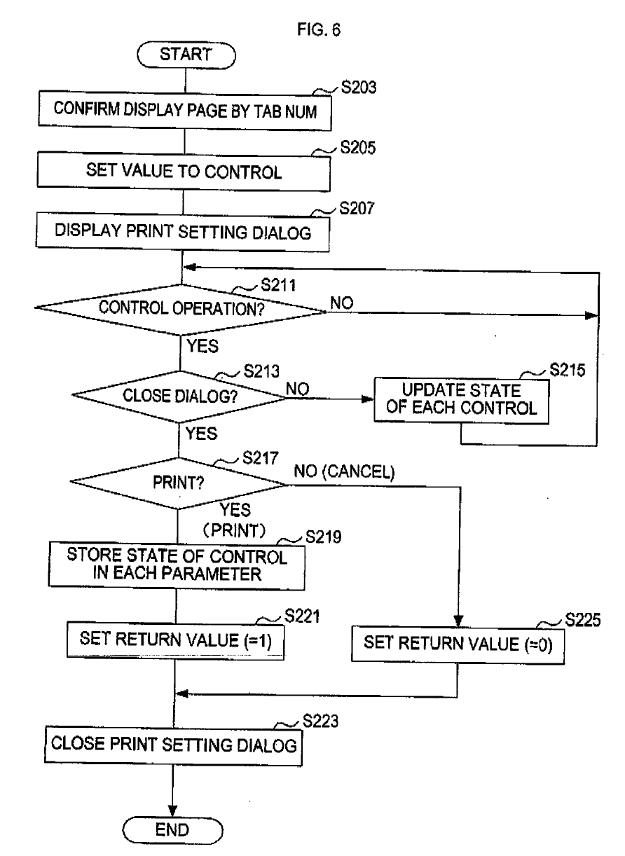

From now on, processes performed by the application software and the printer driver in order to implement a UI with the aforementioned screen image transition will be explained by way of flowcharts in FIGS. 5 and 6. FIG. 6 shows a process performed as an application process when the user started the application software by a predetermined operation on the PC 1. FIG. 6 shows a process performed as a printer driver process when directions for display of the print setting dialog are sent to the printer driver in the application process.

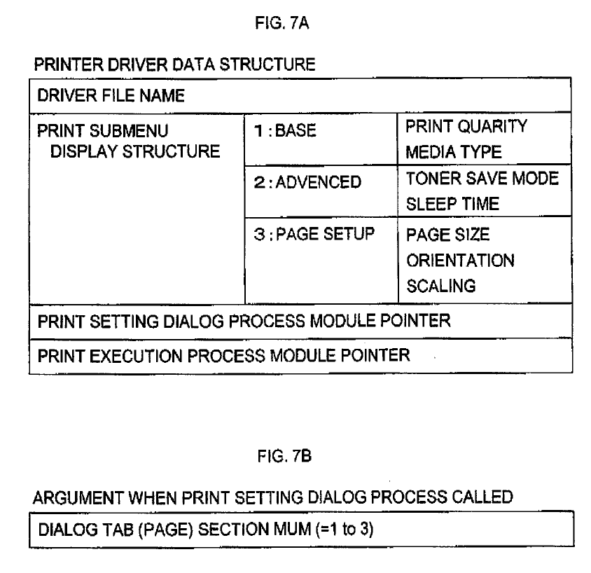

As shown in FIG. 5, when the application process is started, firstly information on a default printer driver is obtained (S101). The default printer driver information is registered in the registry of the PC 1 when the printer driver is installed on the PC 1. The default printer driver information is a group of information as shown in FIG. 7A. The item “Print submenu display structure” is information displayed as an option in the “Print” submenu 37. This item also indicates the three subpages in the print setting dialog box 51. The items “print setting dialog process module pointers and “print execution process module pointer” are pointers to a “print setting dialog process module” and a “print execution process module” included in the printer driver. In a later-described process, by specifying addresses indicated by these pointers to call up the respective process modules, directions to execute the respective processes are given to the printer driver.

Next, a tree structure of a “Print” menu is determined based on the “Print submenu display structure” obtained in S101 (S103). In the case of the “Print submenu display structure” illustrated in FIG. 7A, the hierarchical structure has two tiers, each of which includes two or three options. Accordingly, the structure of the “Print” menu displayed by the application software includes a first tier of the “Print” submenu 37, and a second tier made up of the “Base” submenu 42, the “Advanced” submenu 43, and the “Page Setup” submenu 44, each tier being provided with two or three options (“Base” 38, “Advanced” 39 and “Page Setup” 40 in the “Print” submenu 37; “Print Quality” and “Media Type” in the “Base” submenu 42; “Toner Save Mode” and “Sleep Time” in the “Advanced” submenu 43, and “Page Size”, “Orientation” and “Scaling” in the “Page Setup” submenu 44).

Next, it is determined whether there is an event of “File” menu selection (S105). If negatively determined (S106: NO), other processes are performed (S107). Then, the process returns to S105. In a loop of steps S105 to S107, when there is an event of “File” menu selection (S105: YES), the process moves to S109. The event of “File” menu selection is triggered by the mouse down operation which corresponds to the aforementioned “File” menu selection. The mouse down operation accompanied by the occurrence of the event is detected by the OS and notified to the application software. The step of S107 (other processes) includes various processes executed when there is no event of the “File” menu selection. Processes corresponding to different events are performed in S107. Those other processes are not relevant to the gist of the present invention. Therefore, all such irrelevant processes are referred to as “other processes”. No detailed explanation thereof is given.

When the process moves to S109, the “File” menu 34 is displayed (S109). It is further determined whether there is an event of “Print” menu selection (S111). If there is no event of “Print” menu selection (S111: NO), other processes are performed (S113). Then, the process returns to S111. In a loop of steps S111 to S113, when there is an event of “Print” menu selection (S111: YES), the process moves to S115. The event of “Print” menu selection is triggered by the mouse drag operation which corresponds to the aforementioned operation of moving the focus 36 to the item “Print” 35. The mouse drag operation accompanied by the occurrence of the event is detected by the OS and notified to the application software.

When the process is moved to S115, the menu “Print” 35 is focused so that a first submenu (in the present embodiment, the “Print” submenu 37) is displayed (S115). It is determined whether there is an event of first submenu selection (S117). If there is no event of first submenu selection (S117: NO), other processes are performed (S119). The process returns to S117. In a loop of steps S117 to S119, when there is an event of first submenu selection (S137: YES), the process moves to S121. The event of first submenu selection is triggered by the mouse drag operation which corresponds to the aforementioned operation of moving the focus 41 to one of the items “Base” 38, “Advanced” 89 or “Page Setup” 40. The mouse drag operation accompanied by the occurrence of the event is detected by the OS and notified to the application software. If the mouse drag operation is interrupted by the mouse up operation before the operation of moving the focus 41 to one of the items “Base” 38, “Advanced” 39 or “Page Setup” 40, the process moves to S119. In this case, in S119, display of the print setting dialog box 51 is performed. As previously explained, the process of displaying the print setting dialog box 51 without displaying a later explained second submenu is not different from the process in the prior art. Thus, no detailed explanation is provided.

When the process moves to S121, the first submenu (i.e., one of the items “Base” 38, “Advanced” 39 or “Page Setup” 40) is focused to display the second submenu (in the present embodiment, one of the “Base” submenu 42, the “Advanced” submenu 43, or the “Page Setup” submenu 44) (S121).

Next, it is determined whether there is an event of first submenu decision (S125). When there is no event of first submenu decision (S125: NO), it is determined whether the submenu is unfocused (S127). If the submenu is not unfocused (S127: NO), other processes are performed (S129). The process returns to S125. In a loop of steps S125 to S129, when there is an event of first submenu decision (S125: YES), the process moves to S131. The event of first submenu decision is triggered by the mouse up operation after the aforementioned focus 41 is moved to one of the items “Base” 38, “Advanced” 39 and “Page Setup” 40. The mouse up operation accompanied by the occurrence of the event is detected by the OS and notified to the application software.

In S131, the display of the menu is ended and the tab (page) selection number is set. S131 is a step of setting a value as an argument for use in a later step S133. The tab (page) selection number is set to be “1” when the focus 41 is moved to the item “Base” 38, “2” when the focus 41 is moved to the item “Advanced” 39, and “3” when the focus 41 is moved to the item “Page Setup” 40. The tab (page) selection numbers “” to “3” is defined on the printer driver side. However, the values are included in the “Print submenu display structure” obtained from the registry in S101. Thus, the application software side can also use appropriate values consistent with the values on the printer driver side.

Subsequently, a print setting dialog process is executed (S133). Particularly, in S133, the process module indicated by the “print setting dialog process module pointer” obtained from the registry in S101 is called up. As a result, directions for display of the print setting dialog box 51 are sent to the printer driver, Here, an argument shown in FIG. 7B is delivered from the application software to the printer driver. This argument is the tab (page) selection number set in S131, that is, one of “1” to “3” in accordance with the subpage to be displayed.

Execution of S133 leads to execution of the application process and the printer driver process (see FIG. 6). As a result, the print setting dialog box 51 is displayed. Details of the printer driver process will be explained later.

After the step of S133, a return value from the printer driver process is checked (S135). A different value depending on user operation is returned to the application software side from the printer driver side. Particularly, in the printer driver process, if the print setting dialog box 51 shown in any of FIGS. 4A to 4C is displayed and a Cancel button 55 is clicked by the user, a value 0 is returned from the printer driver side to the application software side. On the other hand, if a Print button 56 is clicked by the user, a value 1 is returned from the printer driver side to the application software side.

In S135, if the return value is equal to 1 (S135: =1), a print execution process is executed (S137) since it is determined that directions for execution of the print process is sent by the user. In S137, particularly, a process module indicated by the “print execution process module pointer” obtained from the registry in S101 is called up. As a result, directions for print execution are sent to the printer driver.

Upon receipt of the directions, the printer driver performs a process of generating print data required for print output by the printer 2 based on the output data from the application software side and the settings in the print setting dialog box 51 displayed by the printer driver, a process of dispatching the print data to the printer 2 by way of a spooler, etc. These processes are not different from the processes in the prior art. Accordingly, the illustrations and detailed descriptions are omitted.

After the step of S137, the process returns to S105 to repeat the steps of S105 and onwards.

If the return value in S135 is equal to 0 (S185: =0), the stops of S137 is skipped since it is determined that directions for the print process is cancelled by the user. In this case, the step of S137 is skipped. The process returns to S105 to repeat the steps of S105 and onwards.

In a loop from S125 to S129, it may be determined that the submenu selection is unfocused (S127: YES). In this case, the first submenu is unfocused to clear the second submenu (S139). Then, the other processes are executed (S141). The process returns to S117. In S141, a process of clearing unnecessary menus and focuses is performed depending on the position of the mouse cursor 31.

That is, before returning to S117, the menus and focuses which are no longer pointed by the mouse cursor 31 and necessary are cleared in the steps of S139 to S141. However, due to the unfocused first submenu selection, if another first submenu is selected, it is positively determined in S117, resulting in that a second submenu corresponding to another first submenu is again displayed. In this case, it appears to the user that the content of the second submenu has been switched. When first submenu selection is unfocused and if no other first submenu is selected, it is negatively determined in S117. In this case, it appears to the user that the display of the print setting dialog box 51 has ended.

Now, the printer driver process executed by the printer driver when the step of S138 is called up in the application process described as above will be described by way of a flowchart in FIG. 6.

When the printer driver process is started, as shown in FIG. 6, it is determined which page should be the forefront according to the tab number delivered as the argument from the application software side (S203). After parameter values are set to the controls (e.g., list box, check box, text box, radio button, etc.) provided on the forefront page (S205), the print setting dialog box 61 is displayed (S207). As a result, the print setting dialog box 51 is displayed in the display portion 16.

Subsequently, it is determined whether the user has performed any operations to the controls in the print setting dialog box 51 (S211). If there is no control operation (S211: NO), the process returns to S211. The process stands by until the user performs any operations to the controls, repeating the loop of step S211.

In this loop of step S211, if the user has performed some operations to the controls (S211: YES), it is determined whether directions for close of the dialog are given (S213). In S213, when the Cancel button 55 or the Print button 56 in the print setting dialog box 51 is clicked, it is determined that the directions for close of the dialog are given. If operations to other controls have been performed, it is determined that no directions for close of the dialog are given,

If it is determined that no directions for close of the dialog are given (S213: NO), the state of each control is updated (S215). The process returns to S211 so as to accept another control operation. In this manner, while it is determined that no directions for close of the dialog are given in S213, the loop of steps S211 to S215 is repeated. Operations by the user to the plurality of controls in the print setting dialog box 51 are kept accepted any number of times.

When it is determined that directions for closing the dialog are given (s213: YES), it is determined whether printing is directed by the user (S217). In S217, if the Print button 56 has been clicked, it is determined that printing is directed. If the Cancel button 55 has been clicked, it is determined that printing is not directed.

If it is determined that printing is directed in S217 (S217: YES), the state of each control is stored in each setting parameter (S219). Thereby, various parameter values which appear to have been modified in the print setting dialog box 51 by the control operation will be stored in a storage area (e.g., registry or temporary storage area provided for execution of the print process this time) preassigned per every setting parameter. The stored values will be referred by the printer driver, for example, when directions for print execution are given to the printer driver from the application software in S137.

Subsequently, a return value to the application software is set to 1 (S221). The print setting dialog box 51 is closed (S223). The printer driver process is ended.

If it is determined in S217 that printing is not directed (S217: NO), the return value to the application software is set to 0 (S225). The process returns to S223 to close the print setting dialog box 51. The printer driver process is ended. In other words, if it is determined in S217 that printing is not directed, any step corresponding to step S219 is not performed. A return value different from the value set in S221 is set. The printer driver process is ended. In this case, even if there are any parameter values which appear to be modified in the print setting dialog box 51 by control operation, the parameter values are not stored in the storage area preassigned for each setting parameter. It is regarded that there has been no modification in setting in the print setting dialog box 51.

As a result of execution of both the above the application process and the printer driver process, the image screen (the application window and the printer driver dialog) displayed on the display 16 of the PC 1 will be shifted as shown in FIG. 2.

[Effects]

According to the above embodiment, only the operation of moving the focus 41 on the menu (more particularly, “Print” submenu 37) displayed by the application software allows the printer driver to display the interdialog information (more particularly, subpage information in the dialog such as the items “Base” 38, “Advanced” 39, and “Page Setup” 40, and parameter information in the dialog such as “Print Quality”, “Media Type”, “Toner Save Mode”, “Sleep Time”, “Page Size”, “Orientation” and “Scaling”) which correspond to at least a part of the information displayed in the dialog box as a part of a menu.

Accordingly, unlike the prior art in which interdialog information can be seen only after the print setting dialog box 51 is displayed, the user can confirm, before performing operations for urging the printer driver to display the print setting dialog box 51, interdialog information (what subpages (groups) or setting parameters there are, or which setting parameter belongs to which subpage (group), etc.) by focus moving operations on the menu.

Also, according to the above embodiment, if the user selects a desired group (one of the items “Base” 38, “Advanced” 39, and “Page Setup” 40), the print setting dialog box 51 is displayed which shows the subpage including the setting parameters belonging to the group in the forefront. Therefore, the desired setting parameter can be easily reached by way of operations on the menu.

### Second Embodiment

The second embodiment will be described hereinafter. In the above-described print processing system according to the first embodiment, a dialog is displayed (formally displayed) by the printer driver when a menu is shifted to another menu. In a print processing system according to the second embodiment, a menu is provisionally displayed before formally displayed.

The block diagram shown in FIG. 1 is common to both the first and the second embodiments. Therefore, the explanation thereof is not repeated.

[Outline of UI in Print Processing System]

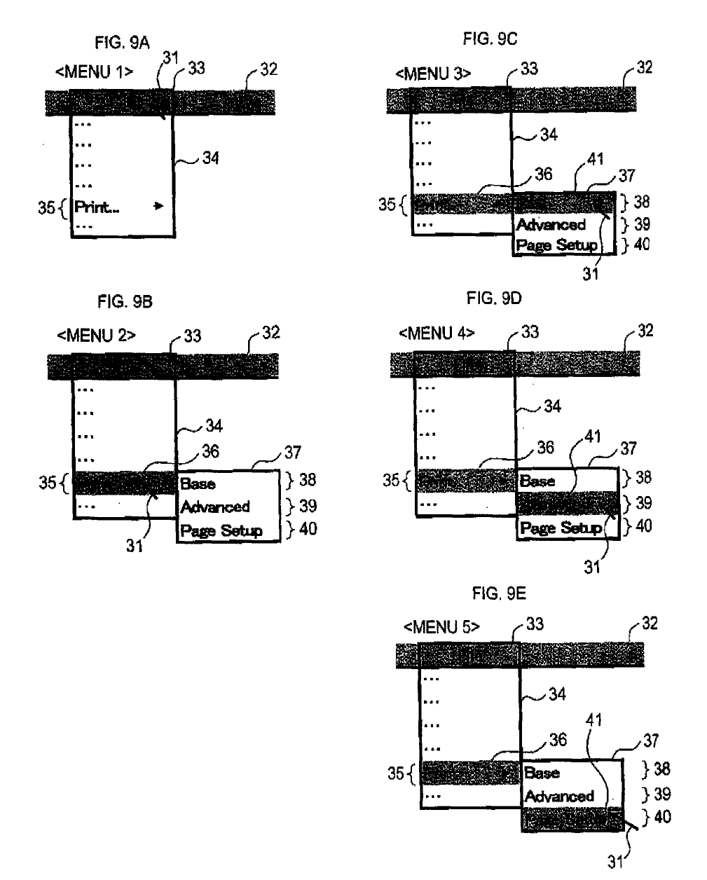

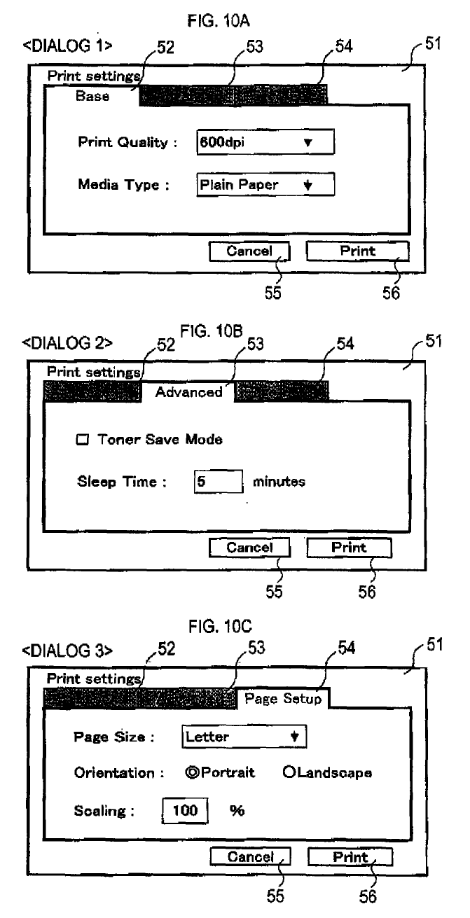

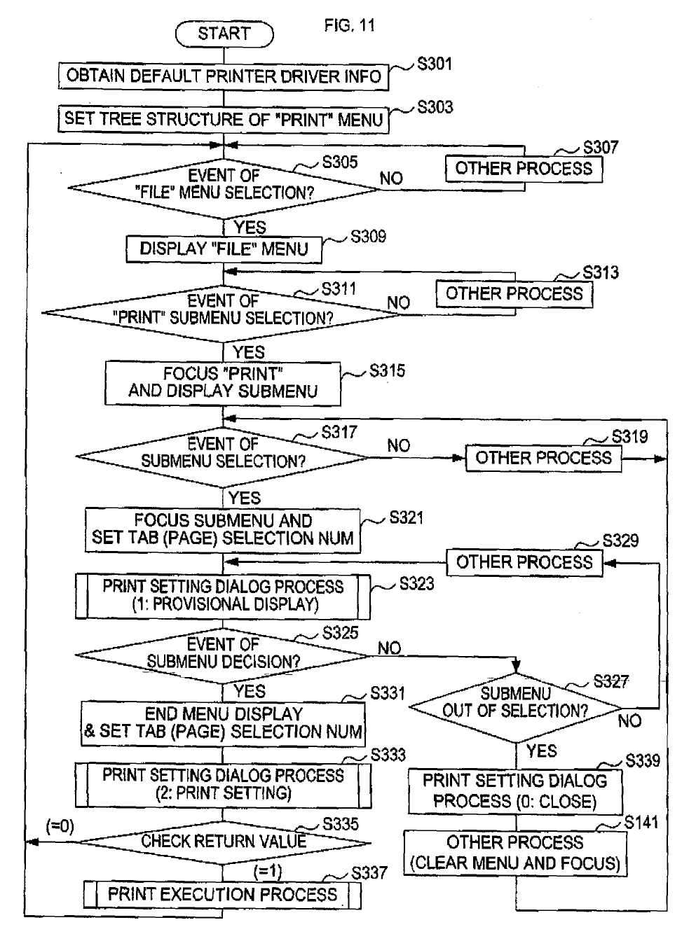

Now, the outline of a UI provided in the print processing system, according to the second embodiment, that operates on the PC 1 will be described by way of FIGS. 9, 10A to 10E and 10A to 10C.

In the following description, a mouse is used as a pointing device. The mouse operation in the present embodiment is the same as the mouse operation in the first embodiment. Therefore, the explanation thereof is not repeated.

As previously noted, the point of the present invention is not that the alternative operations can be performed by other input devices. Furthermore, it will be complex if description is provided for all alternative operations by other output devices. Therefore, only the operations by the mouse will be described in the following description. The particular description of the alternative operations by other input devices will be omitted.

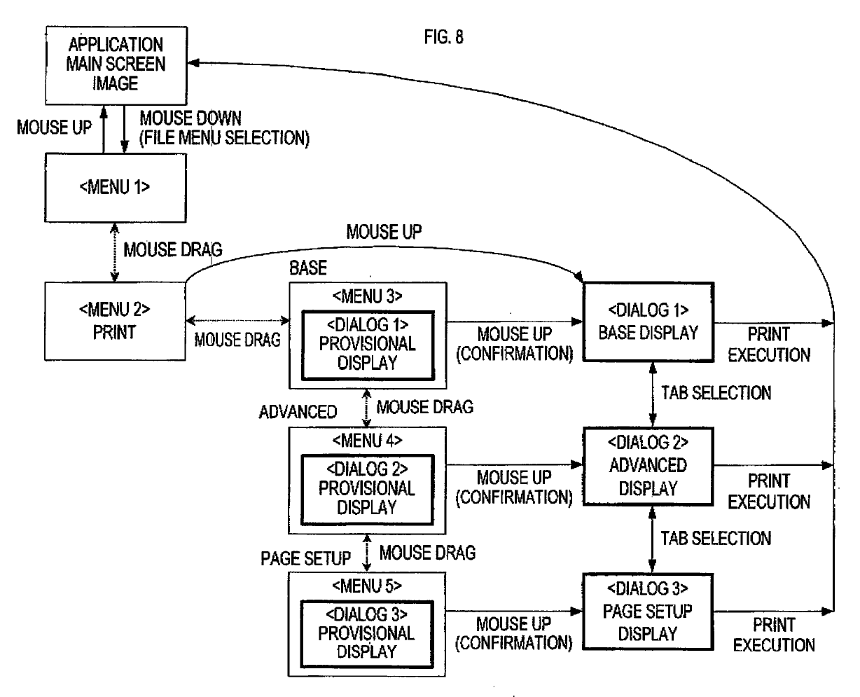

Referring to FIG. 8, an application main screen image, which is located on the upper left upper position of FIG. 8 drawing, is firstly shown on the display portion 16 of the PC 1 when an application software is started on the PC 1.

In the application main screen image, a user can shift the screen image shown by the application software to another screen image shown as <Menu 1> in FIG. 8, by performing a “File” menu selecting operation. More particularly, as shown in FIG. 9A, the application main screen image including a mouse cursor 31 which moves in accordance with a mouse operation and a menu bar 32 is displayed on the display portion 16 of the PC 1. Here, if the user points the item “File” 33 in the menu bar 32 with the mouse cursor 31 by a mouse operation and performs the mouse down operation, it is considered that the “File” menu selecting operation has been conducted. When the “File” menu selecting operation is performed, a “File” menu 34 is shown on the display portion 16. As a result the screen image has shifted to <Menu 1> in FIG. 8. An item “Print” 35 is also displayed with other items in the “File” menu 34.

Next, the user can shift the screen image displayed by the application software from <Menu 1> to <Menu 2> in FIG. 8 by performing the mouse drag operation. More particularly, as shown in FIG. 9B, following the mouse down operation corresponding to the “File” menu selecting operation, the user moves the mouse cursor 31 into the “File” menu 34 by performing the mouse drag operation. Then, a focus 36 which follows the movement of the mouse cursor 31 appears in the “File” menu 34. When the user moves the focus 36 to the item “Print” 35, a “Print” submenu 87 is shown adjacent to the item “Print” 35. In this manner, the screen image is changed to <Menu 2>. The “Print” submenu 37 includes items like “Base” 38, “Advanced” 39 and “Page Setup” 40. The respective items shown in the “Print” submenu 37 indicate what subpages there are in a later-explained print setting dialog. The texts “Base”, “Advanced” and “Page Setup” shown here are information registered in a registry by a printer driver. The information is obtained from the registry by the application software and displayed in the “Print” submenu 37.

Next, the user can shift the screen image displayed by the application software from <Menu 2> to <Menu 3> in FIG. 8 by continuing the mouse drag operation. More particularly, as shown in FIG. 9C, when the user continues the mouse drag operation to move the mouse cursor 31 into the “Print” submenu 37, a focus 41 which follows the movement of the mouse cursor 31 appears in the “Print” submenu 37. When the user moves the focus 41 to the item “Base” 38, the screen image is shifted to <Menu 3>.

Once the screen image displayed by the application software is shifted from <Menu 2> to <Menu 3> shown in FIG. 8, directions for provisional display of a dialog are sent to the printer driver from the application software. The printer driver, upon receipt of the directions, provisionally displays a print setting dialog box 51 shown in FIG. 10A. In the present embodiment, the provisional display means to display the print setting dialog box 51 without acceptance of input operation to various controls (e.g., list box, check box, text box, radio button) in the print setting dialog box 51. In other words, in the case of normal display, input operations to the various controls in the print setting dialog box 51 are accepted. However, in the case of provisional display, no input operation is allowed. In the following description, the normal display is referred to as a formal display when the normal display and the provisional display should be distinguished from each other.

The print setting dialog box 51 displayed by the printer driver includes a “Base” subpage 52, an “Advanced” subpage 53, a “Page Setup” subpage 54, a Cancel button 55 and a Print button 56. The “Base” subpage 52, the “Advanced” subpage 53 and the “Page Setup” subpage 54 include various controls for input or selection of values for setting parameters classified by similar functions as shown in FIGS. 10A to 10C.

The “Base” subpage 52, the “Advanced” subpage 53 and the “Page Setup” subpage 54 are displayed in layers. Only one of the subpages is displayed at the forefront. Which subpage is shown at the forefront is specified on the application software side. The printer driver displays the subpage specified by the application software at the forefront.

Along with the transition of the screen image to <Menu 3> shown in FIG. 8, the application software specifies the “Base” subpage 52 when the print setting dialog box 51 is displayed. This is because the item “Base” 38 on which the focus 41 has moved is associated with the “Base” subpage 52. As a result, the print setting dialog box 51 is displayed such that the “Base” subpage 52 is shown at the forefront. In the following description, the state having the “Base” subpage 52 displayed at the forefront as shown in FIG. 10A is referred to as <Dialog 1>. The state having the “Advanced” subpage 53 displayed at the forefront as shown in FIG. 1013 is referred to as <Dialog 2>. The state having the “Page Setup” subpage 54 displayed at the forefront as shown in FIG. 10C is referred to as <Dialog 3>.

Now, the user can shift the screen image displayed by the application software from <Menu 3> to <Menu 4> shown in FIG. 8 by continuing the mouse drag operation. More particularly, as shown in FIG. 9D, when the user continues the mouse drag operation to move the focus 41 to the item “Advanced” 39, the screen image is shifted to <Menu 4> shown in FIG. 8.

Once the screen image displayed by the application software is shifted from <Menu 3> to <Menu 4> shown in FIG. 8, directions for provisional display of a dialog are sent to the printer driver. The printer driver, upon receipt of the directions, provisionally displays a print setting dialog box 51 shown in FIG. 10B. As a result, the screen image provisionally displayed by the printer driver is shifted from <Dialog 1> to <Dialog 2> shown in FIG. 2.

The user can shift the screen image displayed by the application software from <Menu 4> to <Menu 5> shown in FIG. 8 by continuing the mouse drag operation. More particularly, as shown in FIG. 9E, when the user continues the mouse drag operation to move the focus 41 to the item “Page Setup” 40, the screen image is shifted to <Menu 5> shown in FIG. 8.

Once the screen image displayed by the application software is shifted from <Menu 4> to <Menu 5> shown in FIG. 8, directions for provisional display of a dialog are sent to the printer driver. The printer driver, upon receipt of the directions, provisionally displays a print setting dialog box 51 shown in FIG. 10G. As a result, the screen image provisionally displayed by the printer driver is shifted from <Dialog 2> to <Dialog 3> shown in FIG. 8.

The above described screen image transition from <Menu 1> to <Menu 5> is continued as long as the user continues the mouse drag operation. Every time the screen image transition to <Menu 3>, <Menu 4> or <Menu 5> occurs, <Dialog 1>, <Dialog 2> or <Dialog 3> is provisionally displayed.

When the user performing the mouse drag operation performs the mouse up operation when the screen image displayed by the application software is shifted to <Menu 3>, <Menu 4> or <Menu 5>, a selecting operation of the item “Base” 38, “Advanced” 30 or “Page Setup” 40 is confirmed. All the items “Base” 38, “Advanced” 39 and “Page Setup” 40 indicate submenus for print directions provided for directing the printer driver to display the print setting dialog box 51. When a selecting operation for any of the items is confirmed, the image screen displayed by the printer driver is shifted from the provisional display of any of <Dialog 1>, <Dialog 2> or <Dialog 3> to the formal display. Here, the provisional display of <Dialog 1> is shifted to the formal display of <Dialog 1>, the provisional display of <Dialog 2> is shifted to the formal display of <Dialog 2>, and the provisional display of <Dialog 3> is shifted to the formal display of <Dialog 3>. At the same time, in the screen image displayed by the application software, the whole hierarchical menu including the “File” menu 34 and onwards (the “File” menu 34 and the “Print” submenu 37 in FIGS. 9A to 9E) disappears.

The formally displayed print setting dialog box 51 accepts input operations to the various controls in the print setting dialog box 51, which is different from the case of the provisional display. Accordingly, various operations in the print setting dialog box 61 can be performed hereinafter in the same manner as in the prior art.

For example, if the user selects any of the “Base” subpage 52, the “Advanced” subpage 53 or the “Page Setup” subpage 54 (i.e., clicks one of tabs attached to the upper parts of the respective subpages using the mouse), the display content of the print setting dialog box 51 can be switched to any of <Dialog 1>, <Dialog 2> or <Dialog 3>. Also, the user, after entering desired print settings through input operations to the various controls provided in the respective subpages, can click a Print button 56 in the print setting dialog box 51 to send directions for printing to the printer 2. When the directions for printing are sent to the printer 2, the application software and the printer driver together performs a process of transmitting print data to the printer 2 from the PC 1 in the same manner as in the prior art. At the same time, the printer driver clears the print setting dialog box 51. The application main screen image displayed by the application software remains on the display portion 16 of the PC 1.

If the user performs the mouse up operation immediately after the screen image is shifted to <Menu 2>, the whole hierarchical menu including the “File” menu 34 and onward (the “File” menu 34 and the “Print” submenu 37 in FIGS. 9A to 9E) disappears in the image screen displayed by the application software. The printer driver formally displays <Dialog 1>, In other words, only when <Dialog 1> is desired to be formally displayed, the mouse up operation may be performed immediately after the screen image is shifted to <Menu 2>. In this case, however, the aforementioned provisional display is not performed. This behavior is the same as the behavior in the prior art when a UI of the printer driver is called up by the application software.

[Process Performed by Application Software and Printer Driver]

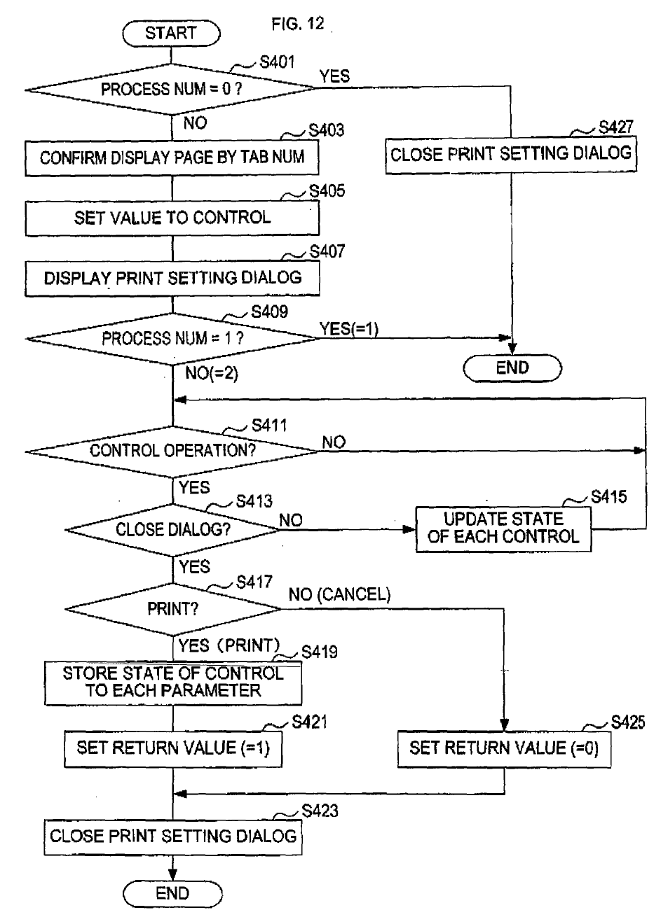

From now on, processes performed by the application software and the printer driver in order to implement a UI with the aforementioned screen image transition will be explained by way of flowcharts in FIGS. 12 and 13. FIG. 11 shows a process performed as an application process when the user started the application software by a predetermined operation on the PC 1. FIG. 12 shows a process performed as a printer driver process when directions for display of the print setting dialog are sent to the printer driver in the application process.

As shown in FIG. 11, when the application process is started, firstly information on a default printer driver is obtained (S301). The default printer driver information is registered in the registry of the PC 1 when the printer driver is installed on the PC 1. The default printer driver information is a group of information as shown in FIG. 13A. The item “Print submenu display structure” is information displayed as an option in the “Print” submenu 37. This item also indicates the three subpages in the print setting dialog box 51. The items “print setting dialog process module pointer” and “print execution process module pointer” are pointers to a “print setting dialog process module” and a “print execution process module” included in the printer driver. In a later-described process, by specifying addresses indicated by these pointers to call up the respective process modules, directions to execute the respective processes are given to the printer driver.

Next, a tree structure of a “Print” menu is determined based on the “Print submenu display structure” obtained in S301 (S303). In the case of the “Print submenu display structure” illustrated in FIG. 13A, the hierarchical structure has one tier including three options. Accordingly, the structure of the “Print” menu displayed by the application software includes one tier of the “Print” submenu 37 provided with three options (the “Base” 38, the “Advanced” 39, and the “Page Setup” 40).

Next, it is determined whether there is an event of “File” menu selection (S306). If negatively determined (S305: NO), other processes are performed (S307). Then, the process returns to S305. In a loop of steps S305 to S307, when there is an event of “File” menu selection (S305: YES), the process moves to 8309. The event of “File” menu selection is triggered by the mouse down operation which corresponds to the aforementioned “File” menu selection. The mouse down operation accompanied by the occurrence of the event is detected by the OS and notified to the application software. The step of S307 (other processes) includes various processes executed when there is no event of the “File” menu selection. Processes corresponding to different events are performed in S307. Those other processes are not relevant to the gist of the present invention. Therefore, all such irrelevant processes are referred to as “other processes”. No detailed explanation thereof is given.

When the process moves to S309, the “File” menu 34 is displayed (S309). It is further determined whether there is an event of “Print” menu selection (S311). If there is no event of “Print” menu selection (S311: NO), other processes are performed (S313). Then, the process returns to S311. In a loop of steps S311 to S313, when there is an event of “Print” menu selection (S311: YES), the process moves to S315. The event of “Print” menu selection is triggered by the mouse drag operation which corresponds to the aforementioned operation of moving the focus 36 to the item” “Print” 35. The mouse drag operation accompanied by the occurrence of the event is detected by the OS and notified to the application software.

When the process is moved to S315, the menu “Print” 35 is focused so that the first submenu (in the present embodiment, the “Print” submenu 37) is displayed (S315). It is determined whether there is an event of submenu selection (S317). If there is no event of submenu selection (S317: NO), other processes are performed (S319). The process returns to S317. In a loop of steps S317 to S319, when there is an event of submenu selection (S317: YES), the process moves to S321. The event of submenu selection is triggered by the mouse drag operation which corresponds to the aforementioned operation of moving the focus 41 to one of the items “Base” 38, “Advanced” 39 or “Page Setup” 40. The mouse drag operation accompanied by the occurrence of the event is detected by the OS and notified to the application software. If the mouse drag operation is interrupted by the mouse up operation before the operation of moving the focus 41 to one of the items “Base” 38, “Advanced” 39 or “Page Setup” 40, the process moves to S319. In this case, in S319, formal display of the print setting dialog box 51 is performed without provisional display. As previously explained, the process of formal display without provisional display is not different from the process in the prior art. Thus, no detailed explanation is provided.

When the process moves to S321, the submenu (i.e., one of the items “Base” 38, “Advanced” 39 or “Page Setup” 40) is focused to set a tab (page) selection number (S321). S321 is a step of setting a value as an argument for use in a later step of S323. The tab (page) selection number is set to be “1” when the focus 41 is moved to the item “Base” 38, “2” when the focus 41 is moved to the item “Advanced” 39, and “3” when the focus 41 is moved to the item “Page Setup” 40. The tab (page) selection numbers “1” to “3” is defined on the printer driver side. However, the values are included in the “Print submenu display structure” obtained from the registry in S301. Thus, the application software side can also use appropriate values consistent with the values on the printer driver side.

Subsequently, a print setting dialog process (1: provisional display) is executed (S323). Particularly, in S323, the process module indicated by the “print setting dialog process module pointer” obtained from the registry in S301 is called up, As a result, directions for provisional display of the print setting dialog box 51 are sent to the printer driver. Here, two arguments shown in FIG. 13B are delivered from the application software to the printer driver. One of the arguments is the tab (page) selection number set in S321, that is, one of “1” to “3” in accordance with the subpage to be provisionally displayed. The other is a value (hereinafter, referred to as “process number”) for specifying a process content concerning dialogs. When provisional display is desired, the process number is set to “1”. When print settings (i.e., formal display) are desired, the process number is set to “2”. When the end of dialog display (clearing of the dialog) is desired, the process number is set to “0”. In S323, provisional display should be specified. Thus, the process number is set to be “1”.

Execution of S323 leads to execution of the application process and the printer driver process (see FIG. 12). As a result, the print setting dialog box 51 is provisionally displayed. Details of the printer driver process will be explained later.

After S323, it is determined whether there is an event of submenu decision (S325). If there is no event of submenu decision (S325: NO), it is further determined whether submenu selection is unfocused (S327). If it is determined whether submenu selection is not unfocused (S327: NO), other processes are performed (S329). The process returns to S325. In a loop of steps S325 to S329, if there is an event of submenu decision (S325: YES), the process moves to S331. The event of submenu decision occurs by the mouse up operation after the focus 41 is moved onto one of the items “Base” 38, “Advanced” 39 and “Page Setup” 40. The mouse up operation accompanied by the occurrence of the event is detected by the OS and notified to the application software.

In S331, the display of the menu is ended and the tab (page) selection number is set. S331 is a step of setting a value as an argument for use in a later step S333. The same value as the value set in the above S321 is used as the tab (page) selection number set in S331.

Subsequently, a print setting dialog process (2: print setting) is executed (S333). In S333, similarly to the above S323, a process module indicated by the “print setting dialog process module pointer” obtained from the registry in S301 is called up. However, an argument different from the argument in S323 is used. Particularly, S323 and S333 are the same in that two arguments shown in FIG. 13B are delivered to the printer driver from the application software. However, the process number in S323 is “1” for specifying provisional display while the process number in S333 is “2” for specifying print setting (i.e., formal display). The other argument is the tab (page) selection number set in S331. This value is the same as the tab (page) selection number set in S321.

Execution of S333 leads to execution of the application process and the printer driver process (see FIG. 12). As a result, print setting (i.e., formal display) of the print setting dialog box 51 is performed. Details of the printer driver process will be explained later.

After the step of S333, a return value from the printer driver process is checked (S335). A different value depending on user operation is returned to the application software side from the printer driver side. Particularly, in the printer driver process, if the print setting dialog box 51 shown in any of FIGS. 10A to 10C is displayed (i.e., formally displayed) and a Cancel button 55 is clicked by the user, a value 0 is returned from the printer driver side to the application software side. On the other hand, if a Print button 56 is clicked by the user, a value 1 is returned from the printer driver side to the application software side.

In S335, if the return value is equal to 1 (S335: =1), a print execution process is executed (S337) since it is determined that directions for execution of the print process is sent by the user. In S337, particularly, a process module indicated by the “print execution process module pointer” obtained from the registry in S301 is called up. As a result, directions for print execution are sent to the printer driver.

Upon receipt of the directions, the printer driver performs a process of generating print data required for print output by the printer 2 based on the output data from the application software side and the settings in the print setting dialog box 51 displayed by the printer driver, a process of dispatching the print data to the printer 2 by way of a spooler, etc. These processes are not different from the processes in the prior art. Accordingly, the illustrations and detailed descriptions are omitted.

After the step of S337, the process returns to S305 to repeat the steps of S305 and onwards.

If the return value in S335 is equal to 0 (S335: =0), the steps of S337 is skipped since it is determined that directions for the print process is cancelled by the user. In this case, the step of S337 is skipped. The process returns to S305 to repeat the steps of S305 and onwards.

In a loop from S325 to S329, it may be determined that the submenu selection is unfocused (S327: YES). In this ease, the print setting dialog process (0: end) is executed (S339). In the step of S339, similarly to the step of S323 or S333, a process module indicated by the “print setting dialog process module pointer” obtained from the registry in S301 is called up. However, arguments different from the arguments used in S323 and S333 are used in S339. Particularly, S339 is the same with S323 and S333 in that the two arguments shown in FIG. 13B are delivered to the printer driver from the application software. However, in S339, the process number is “0” in order to specify “close” (i.e., clear). The other argument has no meaning in S339, Therefore, any value (e.g., 0) may be entered.

Execution of S333 leads to execution of the application process and the printer driver process (see FIG. 12). As a result, the print setting dialog box 51 is closed (i.e., cleared). Details of the printer driver process will be explained later.

After the step of S333, the other processes are executed (S341). The process returns to S317. In S341, a process of clearing unnecessary menus and focuses is performed depending on the position of the mouse cursor 31.

That is, before returning to S317, the print setting dialog box 51 provisionally displayed is cleared in S339. The menus and focuses which are no longer pointed by the mouse cursor 31 and necessary are also cleared in S341. However, due to the unfocused menu selection, if another submenu is selected, it is positively determined in S317, resulting in that the print setting dialog box 51 is again provisionally displayed. In this case, it appears to the user that the content of provisional display of the print setting dialog box 51 has been switched. When submenu selection is unfocused and if no other submenu is selected, it is negatively determined in S317. In this case, it appears to the user that provisional display of the print setting dialog box 51 has ended.

Now, the printer driver process executed by the printer driver when one of the steps S323, S333 or S339 is called up in the application process described as above will be described by way of a flowchart in FIG. 12.

When the printer driver process is started, as shown in FIG. 12, it is determined whether the process number is equal to 0 (S401). The process number is the value delivered as an argument from the application software side when the printer driver is called by the respective steps of S323, S333 or S339 during the application process. In the case of S323, “1” is delivered. In the case of S333, “2” is delivered. In the case of S339, “0” is delivered.

That is, in S401, if it is determined that the process number is not equal to 0 (S401: NO), this means that directions for either provisional display or formal display of a dialog box is given by the application software side. Thus, in this case, it is determined which page should be the forefront according to the tab number delivered as the other argument from the application software side (S408). After parameter values are set to the controls (e.g., list box, check box, text box, radio button, etc.) provided on the forefront page (S405), the print setting dialog box 51 is displayed (S407). As a result, the print setting dialog box 51 is displayed in the display portion 16.

Subsequently, it is determined whether the process number is equal to 1 (S409). If it is determined that the process number is not equal to 1 (S409: NO), this means that directions for formal display of a dialog box is given from the application software side. Thus, it is determined whether the user has performed any operations to the controls in the print setting dialog box 51 (S411). If there is no control operation (S411: NO), the process returns to S411. The process stands by until the user performs any operations to the controls, repeating the loop of step S411.

In this loop of step S411, if the user has performed some operations to the controls (S411: YES), it is determined whether directions for close of the dialog are given (S413). In S413, when the Cancel button 55 or the Print button 56 in the print setting dialog box 51 is clicked, it is determined that the directions for close of the dialog are given. If operations to other controls have been performed, it is determined that no directions for close of the dialog are given.

If it is determined that no directions for close of the dialog are given (S418: NO), the state of each control is updated (S415). The process returns to S411 so as to accept another control operation. In this manner, while it is determined that no directions for close of the dialog are given in S413, the loop of steps S411 to S415 is repeated. Operations by the user to the plurality of controls in the print setting dialog box 51 are kept accepted any number of times.

When it is determined that directions for closing the dialog are given (S413: YES), it is determined whether printing is directed by the user (S417). In S417, if the Print button 56 has been clicked, it is determined that printing is directed. If the Cancel button 55 has been clicked, it is determined that printing is not directed.

If it is determined that printing is directed in S417 (S417: YES), the state of each control is stored in each setting parameter (S419). Thereby, various parameter values which appear to have been modified in the print setting dialog box 51 by the control operation will be stored in a storage area (e.g., registry or temporary storage area provided for execution of the print process this time) preassigned per every setting parameter. The stored values will be referred by the printer driver, for example, when directions for print execution are given to the printer driver from the application software in S337.

Subsequently, a return value to the application software is set to 1 (S421). The print setting dialog box 51 is closed (S423). The printer driver process is ended.

If it is determined in S417 that printing is not directed (S417: NO), the return value to the application software is set to 0 (S425). The process returns to S423 to close the print setting dialog box 51. The printer driver process is ended. In other words, if it is determined in S417 that printing is not directed, any step corresponding to step S419 is not performed. A return value different from the value set in S421 is set. The printer driver process is ended. In this case, even if there are any parameter values which appear to be modified in the print setting dialog box 51 by control operation, the parameter values are not stored in the storage area preassigned for each setting parameter. It is regarded that there has been no modification in setting in the print setting dialog box 51.

The above is the flow of steps when formal display of a dialog box is directed by the application software side. If provisional display of a dialog box is directed by the application software side, it will be positively determined in S409. That is, in S409, it is determined that the process number is equal to 1 (S409: YES). In this case, the printer driver process is ended without proceeding further.

If the printer driver process is ended as above, the print setting dialog box 51 remains on the display portion 16. However, steps S411 to S423 are not executed. Accordingly, even if the user attempts to perform any operations (e.g., various selection operations and character input operations) to the controls in the print setting dialog box 51, such operations are ignored and unaccepted. That is, it is determined in S409 whether the directions received from the application software are for provisional or formal display. As a result, it is determined whether or not control operation is accepted. In the case of directions for provisional display, no operation to the controls is accepted so as to prohibit any change to the settings.

Furthermore, the above described flow of steps show the cases when it is negatively determined in S401. However, if clearing of the dialog box is directed by the application software side, it will be positively determined in S401. That is in S401, it is determined that the process number is equal to 0 (S401: YES). In this case, the print setting dialog box 51 is closed (S427). The printer driver process is ended.

As a result of execution of both the above the application process and the printer driver process, the image screen (the application window and the printer driver dialog) displayed on the display 16 of the PC 1 will be shifted as shown in FIG. 8.

[Effects]

According to the above embodiment, only the operation of moving the focus 41 on the menu (more particularly, “Print” submenu 37) displayed by the application software allows the printer driver to provisionally display the print setting dialog box 61. Moreover, the groups including classified setting parameters to be provisionally displayed can be switched as desired. That is, the subpage provisionally displayed in the print setting dialog box 51 can be switched to the “Base” subpage 52, the “Advanced” subpage 53 or the “Page Setup” subpage 54 only by the operation of moving the focus 41 on the menu to any of the items “Base” 38, “Advanced” 39 or “Page Setup” 40.

Accordingly, unlike the prior art in which tab selecting operation in the print setting dialog box is necessary after the print setting dialog box is displayed, high operability and convenience are achieved. Also, even if the user does not know which group includes the desired setting parameter, the operation of moving the focus 41 on the menu displayed by the application software enables provisional display of the group including the desired setting parameter in the provisionally displayed print setting dialog box 51. Therefore, the desired setting parameter can be reached in an extremely easy manner.

In the above PC 1, provisional display of the print setting dialog box 51 is performed which does not allow change in parameter values of the setting parameters when the mouse drag operation is being performed to move the focus 41. When the mouse up operation is performed to confirm selection, formal display is performed which allows change in parameter values of the setting parameters. Accordingly, the situation can be avoided in which parameter values of the setting parameters may be changed even though the user does not perform decisive operation.

Also, according to the above embodiment, if there is an operation of moving the focus to another item in S327, S339 and S341, provisional display disappears. Thus, only during the period in which the focus is moved to one of the items “Base” 38, “Advanced” 39 and “Page Setup” 40, provisionally display can be performed. There are no such cases like only provisional display is left although the focus is moved to another item.

[Variations]

In the above, the embodiments of the present invention have been described. However, the present invention is not limited to the above particular embodiments. The present invention can be practiced in various manners.

For instance, in the above embodiments, the operation of moving the focus to the item on the menu is associated as mouse drag operation while the operation of confirming selection of the item to which the focus is moved is associated as mouse up operation. However, each operation can be associated with different operations. Particularly, for example, the operation of moving the focus to the item on the menu way be associated with the operation of moving the mouse cursor without mouse down operation. Then, the operation of confirming selection of the item to which the focus is moved may be associated with click operation. In this case as well, the operation of moving the focus to the item on the menu provides provisional display of the print setting dialog box 51 in the first embodiment. Thus, unlike the prior art without such provisional display function, access becomes easy to a desired subpage in the print setting dialog box 61.

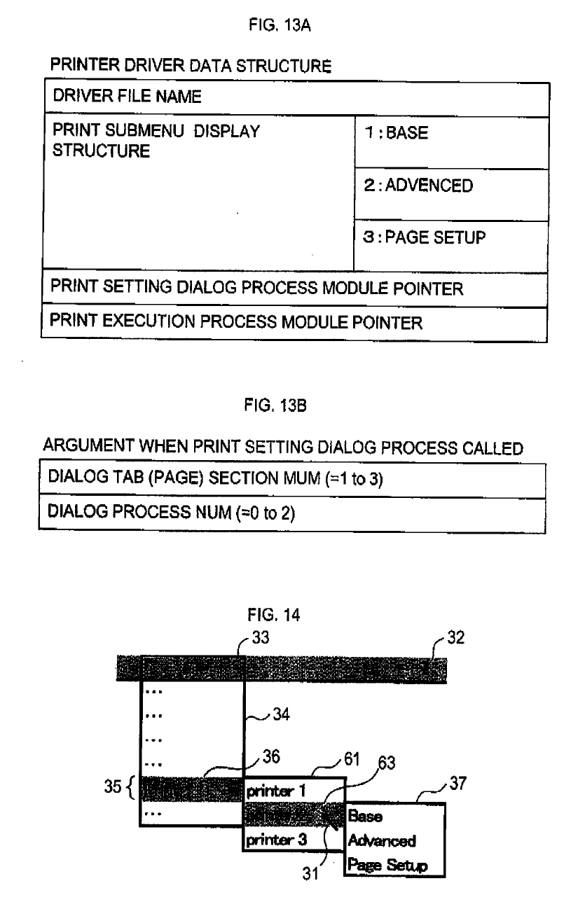

Also in the above embodiments, the item “Print” 35 in the “File” menu 34 is associated with the default printer of the PC 1. However, the item “Print” 35 may be associated with a plurality of printers. The menu structure may be designed such that one printer can be selected in a submenu provided in a lower tier. More particularly, for example, as shown in FIG. 14, when the operation of moving the focus 36 to the item “Print” 35 in the “File” menu is performed, a printer selection submenu 61 may be displayed. Names of the plurality of printers may be displayed in the printer selection submenu 61. When the operation of moving a focus 63 to one of the printer names in the printer selection submenu 61, a submenu corresponding to the “Print” submenu 37 described in the above embodiments may be displayed as a submenu of the selected printer name. Constituted as such, interdialog information can be displayed in the menu per each of the plurality of printers, in the case of the first embodiment. As a result, the user can confirm the interdialog information of each printer to determine whether there is a desired printer driver and whether display of the dialog box is necessary. In the case of the second embodiment, provisional display of the print setting dialog can be achieved for each of the plurality of printers.

Also in the above embodiments, the tab selecting operation allows switching among the plurality of subpages provided in the print setting dialog box 51 to be displayed in the forefront. However, the subpages may be of different forms, for example, without tabs.

What is claimed is:

1. A print processing system comprising
an information processing apparatus;
a printer that is connected to the information apparatus; and
an application software and a printer driver that function on the information processing apparatus,
the application software and the printer driver cooperating with each other to perform a process of transmitting print data from the information processing apparatus to the printer,
the printer driver including:
a dialog box display module that is capable of displaying a dialog box regarding print settings in response to directions from the application software,
the application software including:
an interdialog information acquiring module that acquires interdialog information corresponding to at least a part of information displayed in the dialog box by the printer driver; and
a menu display module that is capable of displaying a menu having a hierarchical structure including print directive items provided for directing the printer driver to display the dialog box, and, when there is an operation of moving a focus to the print directive items, displays the interdialog information obtained by the interdialog information acquiring module as a submenu of the print directive items.

2. The print processing system according to claim 1 wherein
the dialog box display module, when displaying the dialog box, is capable of displaying setting parameters belonging to one of a plurality of groups specified by the application software as initial display contents,
the interdialog information acquiring module acquires the plurality of group information corresponding to the plurality of groups as the interdialog information,
the menu display module displays the plurality of group information acquired by the interdialog information acquiring module as a submenu of the print directive items,
the application software further includes
a dialog box display directive module that, when there is an operation of moving a focus to one of the plurality of group information in the menu displayed by the menu display module and when there is an operation of confirming selection of the focused group information, specifies the group corresponding to the selected one of the group information and directs the printer driver to display the dialog box.

3. The print processing system according to claim 2 wherein
the interdialog information acquiring module acquires setting parameter information corresponding to the setting parameters belonging to each of the plurality of groups as the interdialog information,
the menu display module, when there is an operation of moving a focus to one of the plurality of group information displayed as a submenu of the print directive items, displays the setting parameter information acquired by the interdialog information acquiring module as a submenu of one of the group information to which the focus is moved.

4. The print processing system according to claim 1 wherein
the information processing apparatus is provided with a plurality of the printer drivers,
the menu display module is capable of displaying a plurality of printer driver information corresponding to the plurality of the printer drivers as a submenu of the print directive items, and, when there is an operation of moving a focus to one of the plurality of printer driver information, displays the interdialog information acquired by the interdialog information acquiring module as a submenu of one of the printer driver information to which the focus is moved.

5. A print processing system comprising:
an information processing apparatus;
a printer that is connected to the information apparatus; and
an application software and a printer driver that function on the information processing apparatus,
the application software and the printer driver cooperating with each other to perform a process of transmitting print data to the printer from the information processing apparatus,
the printer driver including:
a dialog box display module that is capable of displaying a dialog box regarding print settings in response to directions from the application software, and, when displaying the dialog box, displays setting parameters belonging to one of a plurality of groups specified by the application software as initial display contents,
the application software including:
a group information acquiring module that obtains a plurality of group information corresponding to the plurality of groups;
a menu display module that is capable of displaying a menu having a hierarchical structure, includes print directive items provided for directing the printer driver to display the dialog box, and, when there is an operation of moving a focus to the print directive items, displays the plurality of group information obtained by the group information acquiring module as a submenu of the print directive items; and
a dialog box display directive module that specifies one of the groups corresponding to one of the group information to which the focus is moved every time there is an operation of moving a focus to any of the plurality of group information in the menu displayed by the menu display module, and directs the printer driver to display the dialog box.

6. The print processing system according to claim 5 wherein
the printer driver further includes:
a display direction type determination module that determines whether the directions received from the application software are directions for provisional display or for formal display; and
a setting change restriction module that, when it is determined that the directions for formal display are received from the application software by the display direction type determination module, urges the dialog box display module to display the dialog box, and accepts operation to controls in the dialog box and changes parameter values of the setting parameters, while, when it is determined that directions for provisional display are received from the application software by the display direction type determination module, urges the dialog box display module to display the dialog box but accepts no operation to the controls in the dialog box so as to prohibit any change to the parameter values of the setting parameters;
the dialog box display module of the application software sends the directions for provisional display to the printer driver every time an operation of moving a focus to any of the plurality of group information in the menu displayed by the menu display module, while, when an operation of confirming selection of the group information, sends the directions for formal display to the printer driver system.

7. The print processing system according to claim 6, wherein
the printer driver further includes
a clear direction determination module that determines whether the directions received from the application software are clear directions, and
a dialog box clearing module that clears the displayed dialog box when it is determined that the clear directions are received from the application software by the clear directions determination device,
the application software transmits the clear directions to the printer driver when there is an operation of moving a focus out of the plurality of group information in the menu displayed by the menu display module.

8. The print processing system according to claim 5, wherein
the dialog box display module of the printer driver is capable of displaying a plurality of pages respectively corresponding to the plurality of groups in layers in the dialog box, and, when one of the plurality of pages is selected by a user operation, displays the selected page in the forefront, and, when display of the dialog box is directed by the application software and one of the plurality of groups is specified, displays the page corresponding to one of the plurality of groups specified by the application software in the forefront to display the setting parameters belonging to the one of the plurality of groups specified by the application software as initial display contents.

9. An information processing apparatus comprising an application software and a printer driver,
the printer driver including:
a dialog box display module that is capable of displaying a dialog box regarding print settings in response to directions from the application software,
the application software including:
an interdialog information acquiring module that acquires interdialog information corresponding to at least a part of information displayed in the dialog box by the printer driver; and
a menu display module that is capable of displaying a menu having a hierarchical structure including print directive items provided for directing the printer driver to display the dialog box, and, when there is an operation of moving a focus to the print directive items, displays the interdialog information obtained by the interdialog information acquiring module as a submenu of the print directive items.

10. The information processing apparatus according to claim 9 wherein
the dialog box display module, when displaying the dialog box, is capable of displaying setting parameters belonging to one of a plurality of groups specified by the application software as initial display contents,
the interdialog information acquiring module acquires the plurality of group information corresponding to the plurality of groups as the interdialog information,
the menu display module displays the plurality of group information acquired by the interdialog information acquiring module as a submenu of the print directive items,
the application software further includes
a dialog box display directive module that, when there is an operation of moving a focus to one of the plurality of group information in the menu displayed by the menu display module and when there is an operation of confirming selection of the focused group information, specifies the group corresponding to the selected one of the group information and directs the printer driver to display the dialog box.

11. The information processing apparatus according to claim 10 wherein
the interdialog information acquiring module acquires setting parameter information corresponding to the setting parameters belonging to each of the plurality of groups as the interdialog information,
the menu display module, when there is an operation of moving a focus to one of the plurality of group information displayed as a submenu of the print directive items, displays the setting parameter information acquired by the interdialog information acquiring module as a submenu of one of the group information to which the focus is moved.

12. The information processing apparatus according to claim 9 wherein
the information processing apparatus is provided with a plurality of the printer drivers,
the menu display module is capable of displaying a plurality of printer driver information corresponding to the plurality of the printer drivers as a submenu of the print directive items, and, when there is an operation of moving a focus to one of the plurality of printer driver information, displays the interdialog information acquired by the interdialog information acquiring module as a submenu of one of the printer driver information to which the focus is moved.

13. An information processing apparatus comprising an application software and a printer driver,
the printer driver including:
a dialog box display module that is capable of displaying a dialog box regarding print settings in response to directions from the application software, and, when displaying the dialog box, displays setting parameters belonging to one of a plurality of groups specified by the application software as initial display contents,
the application software including:
a group information acquiring module that obtains a plurality of group information corresponding to the plurality of groups;
a menu display module that is capable of displaying a menu having a hierarchical structure, includes print directive items provided for directing the printer driver to display the dialog box, and, when there is an operation of moving a focus to the print directive items, displays the plurality of group information obtained by the group information acquiring module as a submenu of the print directive items; and
a dialog box display directive module that specifies one of the groups corresponding to one of the group information to which the focus is moved every time there is an operation of moving a focus to any of the plurality of group information in the menu displayed by the menu display module, and directs the printer driver to display the dialog box.

14. The information processing apparatus according to claim 13 wherein
the printer driver further includes:
a display direction type determination module that determines whether the directions received from the application software are directions for provisional display or for formal display; and
a setting change restriction module that, when it is determined that the directions for formal display are received from the application software by the display direction type determination module, urges the dialog box display module to display the dialog box, and accepts operation to controls in the dialog box and changes parameter values of the setting parameters, while, when it is determined that directions for provisional display are received from the application software by the display direction type determination module, urges the dialog box display module to display the dialog box but accepts no operation to the controls in the dialog box so as to prohibit any change to the parameter values of the setting parameters;
the dialog box display module of the application software sends the directions for provisional display to the printer driver every time an operation of moving a focus to any of the plurality of group information in the menu displayed by the menu display module, while, when an operation of confirming selection of the group information, sends the directions for formal display to the printer driver system.

15. The information processing apparatus according to claim 14, wherein
the printer driver further includes
a clear direction determination module that determines whether the directions received from the application software are clear directions, and
a dialog box clearing module that clears the displayed dialog box when it is determined that the clear directions are received from the application software by the clear directions determination device,
the application software transmits the clear directions to the printer driver when there is an operation of moving a focus out of the plurality of group information in the menu displayed by the menu display module.

16. The information processing apparatus according to claim 13, wherein
the dialog box display module of the printer driver is capable of displaying a plurality of pages respectively corresponding to the plurality of groups in layers in the dialog box, and, when one of the plurality of pages is selected by a user operation, displays the selected page in the forefront, and, when display of the dialog box is directed by the application software and one of the plurality of groups is specified, displays the page corresponding to one of the plurality of groups specified by the application software in the forefront to display the setting parameters belonging to the one of the plurality of groups specified by the application software as initial display contents.

17. A computer usable medium comprising computer readable instructions to cause a computer to execute steps of:
obtaining interdialog information corresponding to at least a part of information displayed in a dialog box regarding print settings displayed by a printer driver;
displaying a menu having a hierarchical structure including print directive items provided for directing the printer driver to display the dialog box;
moving a focus to the print directive items in the menu; and
displaying the obtained interdialog information as a submenu of the print directive items in accordance with the movement of the focus.

18. A computer usable medium comprising computer readable instructions to cause a computer to execute steps of:
obtaining a plurality of group information corresponding to a plurality of groups, each of the plurality of groups including setting parameters displayed per group as initial display contents by a printer driver;
displaying a menu having a hierarchical structure including print directive items provided for directing the printer driver to display the dialog box;
moving a focus to the print directive items in the menu;
displaying the obtained plurality of group information as a submenu of the print directive items; and
specifying one of the groups corresponding to one of the group information to which the focus is moved in accordance with the movement of the focus to any of the plurality of group information, and directing the printer driver to display the dialog box.
